(19) United States
(12) Patent Application Publication
(10) Pub. No.: US 2013/0344233 A1
(43) Pub. Date: Dec. 26, 2013

(54) PROCESS FOR PREPARING A SOLID STATE ELECTROLYTE USED IN AN ELECTROCHEMICAL CAPACITOR

(71) Applicant: National Kaohsiung University of Applied Sciences, (US)

(72) Inventors: Tar-Hwa Hsieh, Kaohsiung City (TW); Hung-Shiang Chen, Tainan City (TW); Min-Hsun Hsieh, Burnaby (CA)

(73) Assignee: National Kaohsiung University of Applied Sciences, Kaohsiung (TW)

(21) Appl. No.: 13/774,943

(22) Filed: Feb. 22, 2013

(30) Foreign Application Priority Data
Jun. 22, 2012 (TW) 101122463

(51) Int. Cl. H01G 9/00

(52) U.S. Cl. CPC H01G 9/0036
USPC 427/80

(57) ABSTRACT

A process for preparing a solid state electrolyte used in an electrochemical capacitor includes the steps of: (a) preparing a mixture of a water-retaining clay-based mineral component and a film-forming hydroxyl-containing polymer component; (b) subjecting the mixture to a crosslinking reaction so as to form a polymer matrix membrane including a polymer matrix and an ion-permeable film; and (c) treating the polymer matrix membrane with an aqueous solution which includes a plurality of positive and negative ions so as to permit the positive and negative ions to permeate the ion-permeable film to be retained in the polymer matrix, thereby forming the solid state electrolyte.

### CROSS-REFERENCE TO RELATED APPLICATION

This application claims priority of Taiwanese application no. 101122463, filed on Jun. 22, 2012.

### BACKGROUND OF THE INVENTION

1. Field of the Invention

This invention relates to a process for preparing a solid state electrolyte used in an electrochemical capacitor.

2. Description of the Related Art

An electrochemical capacitor includes two electrodes and an electrolyte disposed between the electrodes. In order to increase the capacitance of the electrochemical capacitor, the electrolyte preferably has a relatively low impedance. That is, the ionic conductively material in the electrolyte preferably has higher concentration and ionic conductivity. In general, an aqueous electrolyte or an organic solvent electrolyte is known as a liquid state electrolyte, whereas an electrolyte in a solid state is known as a solid state electrolyte. In some of the commercial electrochemical capacitors, the electrolytes are mainly composed of a sulfuric acid solution. However, such commercial electrochemical capacitors have poor stability at a temperature higher than 85° C. A decomposition potential for the sulfuric acid is about 1.2 volt. Thus, such commercial electrochemical capacitors have poor heat stability and are unsuitable for serving as a high-voltage device. Besides, the sulfuric acid solution is hard to be packaged and is likely to damage packaging materials and leak out of the electrochemical capacitors.

A solid state electrolyte plays the role of a separator for the electrodes, and should be provided with an ionic conductivity ranging from 10⁻⁴ S/cm to 10⁻³ S/cm. The solid state electrolytes can be sorted into the following three types: (a) gel-polymer electrolytes (GPEs), (b) composite polymer electrolytes (CPEs), and (c) solid polymer electrolytes (SPEs). In 1973, Wright et al. first reported a solid state electrolyte of crystalline composite which is made by mixing polyethylene oxide (PEO) with potassium thiocyanate (KSCN), and which has an ionic conductivity greater than 10⁻⁴ S/cm at a temperature greater than 60° C. Thereafter, many researches have been focused on solid state electrolytes. For example, Chun-Chen Yang et al. proposed “All solid-state electric double-layer capacitors based on alkaline polyvinyl alcohol polymer electrolytes,” Journal of Power Sources 152 (2005) 303-310.

Generally, a polymer matrix membrane of polyvinyl alcohol (PVA) can be swelled by an aqueous solution to form a plurality of water channels therein. Thus, the swelled PVA membrane can serve as a solid state electrolyte with an increased ionic conductivity. Shangbin Sang et al. proposed “Influences of Bentonite on conductivity of composite solid alkaline polymer electrolyte PVA-Bentonite-KOH—H₂O,” Electrochimica Acta 52 (2007) 7315-7321. In this paper, bentonite was suggested to mixed with PVA to form a PVA/bentonite membrane for enhancing the mechanical properties and the heat stability of the membrane, and a KOH water solution was retained in the PVA/bentonite membrane to obtain a KOH-based solid state electrolyte. However, since KOH has relatively low solubility in the water solution, the ionic conductivity of the KOH-based solid state electrolyte is limited. Accordingly, the KOH-based solid state electrolyte has a relatively low ionic conductivity, and thus a KOH-based electrochemical capacitor made using the KOH-based solid state electrolyte has a relatively low capacitance.

### SUMMARY OF THE INVENTION

An object of the present invention is to provide a process for preparing a solid state electrolyte used in an electrochemical capacitor that can provide a higher capacitance compared to the aforesaid KOH-based electrochemical capacitor.

Accordingly, a process for preparing a solid state electrolyte used in an electrochemical capacitor having two electrodes includes the following steps of:

(a) preparing a mixture of a water-retaining clay-based mineral component and a film-forming hydroxyl-containing polymer component;

(b) subjecting the mixture to a crosslinking reaction in a first aqueous solution to permit a crosslinking of the film-forming hydroxyl-containing polymer component so as to form a polymer matrix membrane with the water-retaining clay-based mineral component dispersed therein, the polymer matrix membrane including a polymer matrix and an ion-permeable film which encloses the polymer matrix and which has two major film surfaces for direct contact with the two electrodes, respectively; and

(c) treating the polymer matrix membrane with a second aqueous solution which includes an ionically conductive material that is dissociable into a plurality of positive and negative ions so as to permit the positive and negative ions in the second aqueous solution to permeate the ion-permeable film to be retained in the polymer matrix, thereby forming the solid state electrolyte.

Preferably, the film forming hydroxyl-containing polymer component includes polyvinyl alcohol; the water-retaining clay-based mineral component includes an inorganic clay; and the second aqueous solution is a sulfuric acid solution.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 shows a schematic view of the preferred embodiment of an electrochemical capacitor according to this invention;

FIG. 2 shows Nyquist plots for an impedance measurement test in Experiment 1;

FIG. 3 shows a graph plotting liquid absorption ratio versus time, for a liquid absorption test in Experiment 1;

FIG. 4 shows a graph plotting size variation ratio versus time, for the liquid absorption test in Experiment 1;

FIG. 5 shows differential scanning calorimetry (DSC) thermographs for a thermo analysis test in Experiment 2;

FIG. 6 shows thermal gravimetric analysis (TGA) traces for the thermo analysis test in Experiment 2;

FIG. 7 shows cyclic voltammetry (CV) results for electrochemical capacitors of Example 10 and Comparative Example 2 for a cyclic voltammetry (CV) test in Experiment 3;

FIGS. 8-10 show CV results for the electrochemical capacitors of Example 10 and Comparative Example 2 after the electrochemical capacitors were each applied with a voltage at 85° C. for 24 hours, 36 hours and 48 hours, respectively;

FIG. 11 shows a CV result for the electrochemical capacitor of Comparative Example 2 after the electrochemical capacitor was applied with the voltage for 60 hours and a CV result for an electrochemical capacitor without an electrolyte (Blank);

FIG. 12 shows a CV result for the electrochemical capacitor of Example 10 after the electrochemical capacitor was applied with the voltage for 60 hours;

FIG. 13 shows a graph plotting the current passing through each electrochemical capacitor versus the potential differential between the two electrodes of each electrochemical capacitor, for a linear sweep voltammetry test in Experiment 3;

FIG. 14 shows Nyquist plots for an impedance measurement test in Experiment 3; and

FIG. 15 shows Bode plots constructed by plotting the logarithm of the magnitude of the impedance (Z′) versus the logarithm of frequency (f), for the impedance measurement test in Experiment 3.

### DETAILED DESCRIPTION OF THE PREFERRED EMBODIMENTS

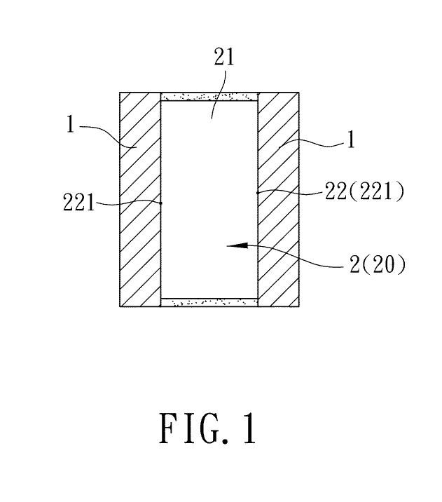

FIG. 1 shows the preferred embodiment of an electrochemical capacitor according to this invention. The electrochemical capacitor includes two spaced apart electrodes 1 and a solid state electrolyte 2 sandwiched between the electrodes 1.

The electrodes 1 are made of a material selected from metals or metal oxides which have a good electrical conductivity. Preferably, in order to provide pseudo-capacitance properties and to increase the available number of charge/discharge cycles, the electrodes 1 are preferably made of ruthenium oxide (RuO₂) or a ruthenium oxide hydrate compound (RuO₂.xH₂O). In the preferred embodiment, the electrodes 1 are made of ruthenium oxide.

The preferred embodiment of a process for preparing the solid state electrolyte according to this invention includes the following steps (a) to (c).

In step (a), a mixture of a water-retaining clay-based mineral component and a film-forming hydroxyl-containing polymer component is prepared and is dispersed in a first aqueous solution. The water-retaining clay-based mineral component is used for retaining an aqueous electrolyte solution therein. In the preferred embodiment, the water-retaining clay-based mineral component includes an inorganic clay selected from mica, montmorillonite, kaolinite, and vermiculite. Preferably, the inorganic clay is modified by quaternary ammonium salt (such as dimethyl dialkyl (C14˜C18) amine). The film-forming hydroxyl-containing polymer component includes polyvinyl alcohol (PVA), which may have a molecular weight ranging from 18000˜4000000, preferably ranging from 90000˜100000.

In step (b), the mixture is subjected to a crosslinking reaction in the first aqueous solution to permit a crosslinking of the film-forming hydroxyl-containing polymer component so as to form a polymer matrix membrane 20. The polymer matrix membrane 20 includes a polymer matrix 21 and an ion-permeable film 22 which encloses the polymer matrix 21, and which has two major film surfaces 221 for direct contact with the two electrodes 1, respectively.

The first aqueous solution is an acid solution, for example, a sulfuric acid solution, for catalyzing the crosslinking reaction. Preferably, in step (b), the PVA is dissolved in water to prepare a PVA aqueous solution, and the inorganic clay is added to mix with the PVA aqueous solution, followed by adding a sulfur acid solution of 1.0M until the pH of the PVA aqueous solution reaches 2˜3, and adding a crosslinking agent which is capable of reacting with the hydroxyl groups of the PVA. The crosslinking agent may be glutaraldehyde, succindialdehyde, oxalaldehyde, or combinations thereof. In the presence of the crosslinking agent in the acid condition, the PVA is subjected to a crosslinking reaction. In order to render the polymer matrix membrane 20 to have better size stability, heat stability, and ionic conductivity, the PVA in the polymer matrix membrane 20 has a crosslinking degree ranging from 75% to 96%, more preferably, from 75% to 88%.

In step (c), the polymer matrix membrane 20 is treated with a second aqueous solution which includes an ionically conductive material that is dissociable into a plurality of positive and negative ions so as to permit the positive and negative ions to permeate the ion-permeable film 22 to be retained in the polymer matrix 21, thereby forming the solid state electrolyte 2. In the preferred embodiment, the polymer matrix membrane 20 is treated with the second aqueous solution for at least 20 hours. The ionically conductive material in the second aqueous solution is sulfuric acid which has a concentration ranging from 1.0M to 3.0M. In consideration of the stability of the polymer matrix membrane 20, the concentration of the sulfuric acid in the second aqueous solution preferably ranges from 1.0M to 2.5M. Because the crosslinked polymer matrix membrane 20 made according to the process of this invention can resist the sulfuric acid solution so as to form the solid state electrolyte 2 with higher ionic conductivity, the electrochemical capacitor made using the solid state electrolyte 2 of this invention can have a higher capacitance compared to the KOH-based electrochemical capacitor of the prior art.

The present invention is explained in more detail below by way of the following examples and comparative examples.

### Experiment 1

### Comparative Example 1 (CE 1)

PVA (polyvinyl alcohol, Mw=90000) was mixed with a water solution at a temperature of 80° C. for 1 hour so as to fully dissolve the PVA to obtain a PVA solution in which the PVA was in an amount of 10 wt %. Then, the PVA solution was stirred at a temperature of 120° C. for 2 hours, followed by cooling to room temperature and drying in a vacuum oven at 60° C. for 12 hours to remove excess water, thereby obtaining a polymer matrix membrane which is a pure PVA membrane.

### Examples 1˜5

PVA was mixed with a water solution at a temperature of 80° C. for 1 hour so as to fully dissolve the PVA to obtain a PVA solution in which the PVA was in an amount of 10 wt %. An inorganic clay which was modified by dimethyl dialkyl (C14˜C18)amine was mixed with the PVA solution at room temperature for 24 hours, followed by ultrasonic vibration for 2 hours, and stirring at a temperature of 80° C. for 2 hours to obtain a gel solution. Thereafter, the gel solution was cooled to room temperature and dried in a vacuum oven at 40° C. for 12 hours for removing excess water, thereby obtaining a polymer matrix membrane which is a PVA/clay membrane. In Examples 1˜5, the inorganic clay was added to the PVA solution in amounts of 3 wt %, 5 wt %, 7 wt %, 9 wt %, and 12 wt %, respectively, based on the total weight of the polymer matrix membranes.

Impedance Measurement Test

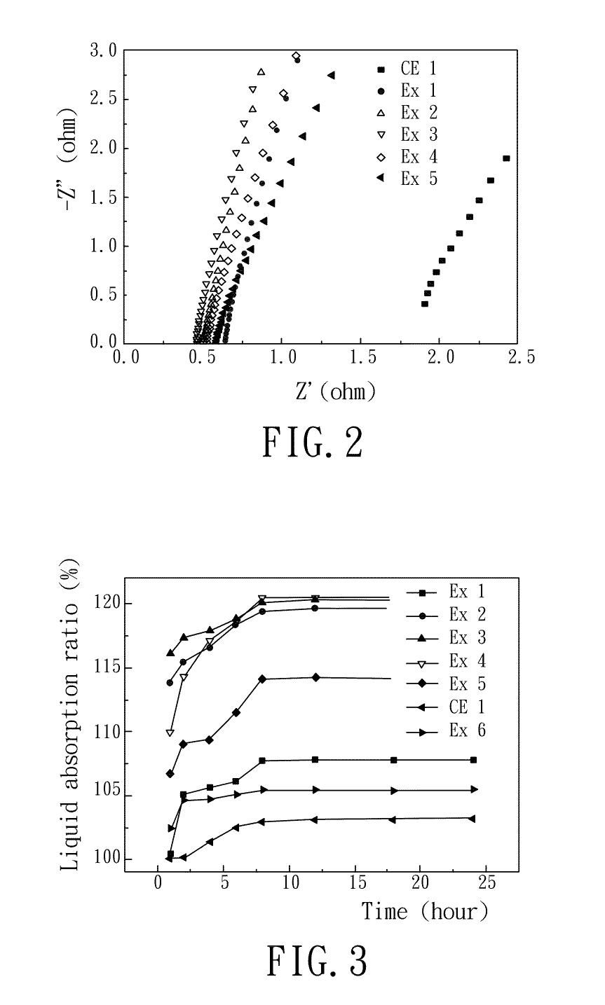

Each polymer matrix membrane obtained in one of Comparative Example 1 and Examples 1 to 5 was sandwiched between two electrodes made of stainless steel, and then connected to a potentiostat/galvanostat (PGSTAT 30, Autolab, Eco-Chemie, Netherland) for measuring an impedance of the polymer matrix membrane using an alternating current method. During the measurement, the potentiostat/galvanostat was controlled to apply a frequency ranging from 50 Hz to 105 Hz with an oscillation amplitude of 100 mV to each polymer matrix membrane. The result for each polymer matrix membrane is shown in the Nyquist plots of FIG. 2. The bulk ionic resistance (Rb) of each polymer matrix membrane was observed from the Nyquist plots shown in FIG. 2, and is listed in the following Table 1.

The ionic conductivity (σ) for each polymer matrix membrane was calculated based on the following equation (I) and is also listed in Table 1:

R_{b}=L/(A·σ) (I)

where A represents an area of each electrode which is in contact with the polymer matrix membrane, and σ represents a distance between the two electrodes (i.e., thickness of the polymer matrix membrane).

TABLE 1

| | Clay | Bulk ionic | Membrane | Ionic |
|---|---|---|---|---|
| | content | resistance | thickness | conductivity |
| membrane | (wt %) | (R_{b}, ohm) | (L, mm) | (σ, S/cm) |
| CE 1 | 0 | 1.735 | 0.20 | 3.67 × 10⁻³ |
| Ex 1 | 3 | 0.622 | 0.20 | 1.02 × 10⁻² |
| Ex 2 | 5 | 0.503 | 0.20 | 1.26 × 10⁻² |
| Ex 3 | 7 | 0.460 | 0.21 | 1.45 × 10⁻² |
| Ex 4 | 9 | 0.513 | 0.21 | 1.30 × 10⁻² |
| Ex 5 | 12 | 0.554 | 0.21 | 1.20 × 10⁻² |

It is found that the polymer matrix membrane of Comparative Example 1, which is a pure PVA film with a semi-crystalline phase, has a relatively high impedance value. The polymer matrix membranes (PVA/clay membranes) of Examples 1 to 5 have relatively low impedance values. With the addition of the inorganic clay, the PVA/clay membrane can be formed with partial intercalated structures for improving the water-retaining property of the membrane. Besides, by increasing the amount of the inorganic clay from 3 wt % to 7 wt %, the ionic conductivity is also increased. It is speculated that the phase of the PVA gradually changes from the semi-crystalline phase to an amorphous phase with the addition of the inorganic clay, and the molecular chains in the amorphous phase structures are more flexible than those in a regularly arranged crystalline phase structure. Thus, ionic transfer in the PVA/clay membrane is enhanced. On the other hand, when the amount of the inorganic clay is greater than 7 wt %, it is adverse to the water-retaining property of the PVA/clay membrane, and the ionic conductivity of the PVA/clay membrane is thus reduced. Accordingly, the amount of the inorganic clay preferably ranges from 3 wt % to 7 wt % based on the total weight of the polymer matrix membrane.

### Example 6

PVA was mixed with a water solution at a temperature of 80° C. for 1 hour so as to fully dissolve the PVA and obtain a PVA solution in which the PVA was in an amount of 10 wt %. An inorganic clay which was modified by dimethyl dialkyl (C14˜C18)amine was mixed with the PVA solution at room temperature for 24 hours, followed by ultrasonic vibration for 2 hours, and stirring at a temperature of 80° C. for another 2 hours to obtain a gel solution. A sulfur acid solution of 1.0M was added to the gel solution until the pH of the gel solution reached 2˜3, followed by addition of 400 μL of a glutaraldehyde aqueous solution in which the concentration of glutaraldehyde was 25 wt % for mixing for 5 min to 10 min, cooling to room temperature and drying in a vacuum oven at 40° C. for 12 hours to remove excess water, thereby obtaining a polymer matrix membrane which is a PVA/clay membrane. In Example 6, the inorganic clay was added in an amount of 7 wt % based on the total weight of the polymer matrix membrane.

Liquid Absorption Test

Seven samples of the polymer matrix membranes obtained respectively in Comparative Example 1 and Examples 1˜6 were prepared. Each polymer matrix membrane was treated using a sulfuric acid solution (1M), and its weight was measured before the treatment and after being treated over a period of 24 hours. The liquid absorption ratio and the size variation ratio for each polymer matrix membrane were calculated based on the following equations (II) and (III), respectively:

Liquid absorption ratio=(W₁−W₀)/W₀×100% (II)

Size variation ratio=(V₁−V₀)/V₁×100% (III)

wherein W₀ is the weight of the polymer matrix membrane before the treatment, W₁ is the weight of the polymer matrix membrane after the treatment, V₀ is the volume of the polymer matrix membrane before the treatment, and V₁ is the volume of the polymer matrix membrane after the treatment.

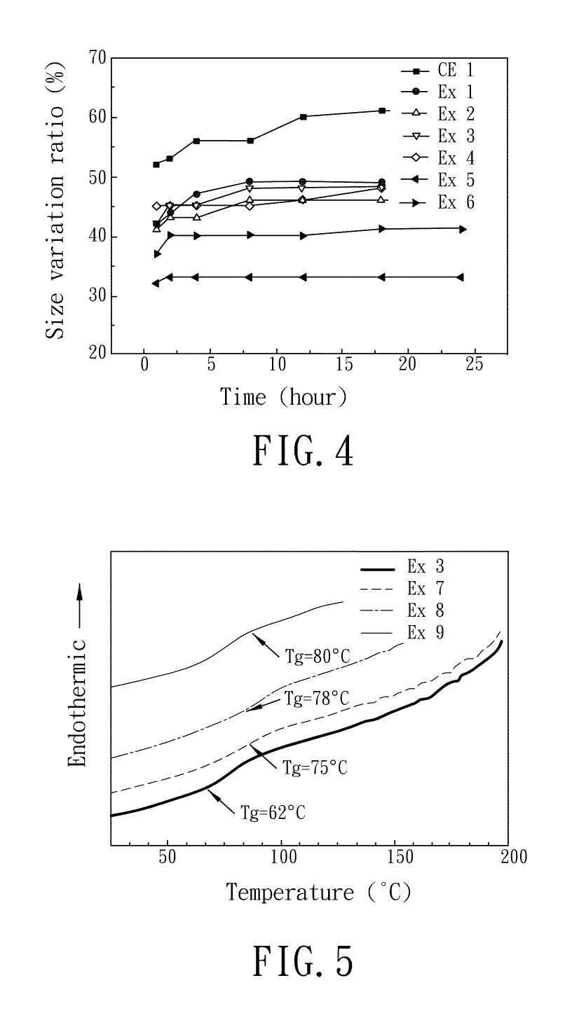

FIG. 3 shows a graph plotting liquid absorption ratio versus time, and FIG. 4 shows a graph plotting size variation ratio versus time. It is noted that the pure PVA membrane (Comparative Example 1) has the lowest liquid absorption ratio and the highest size variation ratio. When the amount of the inorganic clay is increased from 3 wt % to 7 wt % (Examples 1˜3) is increased, the liquid absorption ratio is also increased. When the amount of the inorganic clay is greater than 7 wt %, the water retaining property of the membrane is gradually reduced (see Examples 4˜5). The polymer matrix membrane of Example 6, which was subjected to the crosslinking reaction and included 7 wt % inorganic clay, has an improved size variation ratio compared to Example 3 which was not crosslinked and included 7 wt % inorganic clay.

### Experiment 2

### Examples 7˜9

Polymer matrix membranes of Examples 7˜9 were prepared following the procedure employed in Example 6 except that, in Examples 7˜9, the added amounts of the glutaraldehyde aqueous solution (the crosslinking agent) were 30 μl, 50 μl and 100 μl, respectively.

Crosslinking Degree

Four samples of the polymer matrix membranes obtained respectively in Example 3 and 7˜9 were prepared. Each polymer matrix membrane was weighed using a scale to obtain an initial weight (W₀), and was then immersed in a water bath of 100° C. for 24 hours, dried and further weighed using the scale to obtain a residual weight (W₂). The crosslinking degree for each polymer matrix membrane was determined by the following equation (IV), and is listed in the following Table 2.

Crosslinking degree=(W₂/W₀)×100% (IV)

TABLE 2

| | Crosslinking agent | Crosslinking |
|---|---|---|
| | (μl) | degree (%) |
| Ex 7 | 30 | 75 |
| Ex 8 | 50 | 81 |
| Ex 9 | 100 | 88 |

Thermo Analysis

Four samples of the polymer matrix membranes obtained respectively in Examples 3 and 7˜9 were prepared and were subjected to thermo analysis using a differential scanning calorimeter (DSC, JADE DSC, PerkinElmer). The DSC was performed under nitrogen gas and was set to scan from 0° C. to 200° C. at a heating rate of 10° C./min. FIG. 5 shows the DSC analysis result.

From the DSC analysis result, it is found that the glass transition temperatures for the polymer matrix membranes of Examples 3 and 7˜9 are 62° C., 75° C., 78° C., and 80° C., respectively. The crosslinking reaction will cause the flexible molecular chains in the polymer matrix membrane to be more rigid, and thus, the glass transition temperature of the polymer matrix membrane increases with the increase in the crosslinking degree.

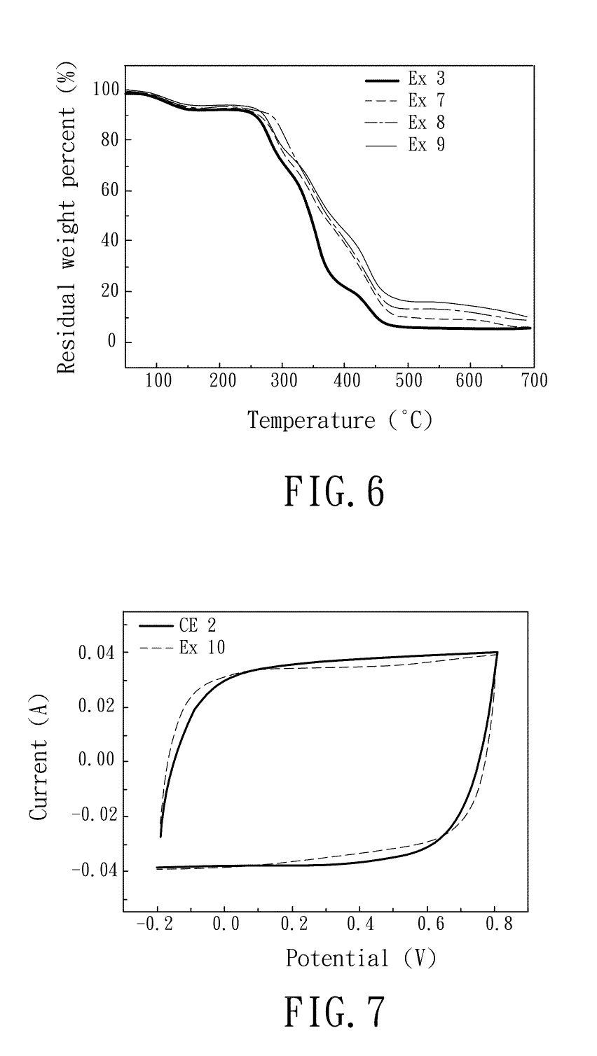

Four samples of the polymer matrix membranes obtained respectively in Examples 3 and 7˜9 were prepared and were subjected to thermo analysis using a thermogravimetric analysis instrument (TGA, SDT-Q600, TA Instruments Inc.) The TGA was performed under nitrogen gas and was set to scan from 50° C. to 700° C. at a heating rate of 10° C./min. FIG. 6 shows the TGA analysis result.

From the TGA analysis result, it is found that the polymer matrix membrane of Example 3, which is not crosslinked, started to decompose at a temperature about 250° C., and was almost decomposed at a temperature about 480° C. The crosslinking degree of the polymer matrix membranes of Examples 7˜9 can be found in Table 2. The residual weight percent of the polymer matrix membrane increases with an increase in the crosslinking degree of the polymer matrix membrane. Thus, the polymer matrix membrane having a greater crosslinking degree should have better heat stability. In this thermo analysis, the polymer matrix membrane with the crosslinking degree of 88% (Example 9) has the best heat stability.

Acid Resistance Test

In order to enhance the capacitance of the electrochemical capacitor, the solid state electrolyte of this invention is preferably prepared by immersing the polymer matrix membrane in a sulfuric acid solution with a relatively high concentration. In this test, five samples of the polymer matrix membrane prepared according to Example 9 were respectively immersed in sulfuric acid solutions of concentrations of 1.0M, 1.5M, 2.0M, 2.5M, and 3.0M, respectively. It was found that the polymer matrix membrane was partially dissolved in the sulfuric acid solution of 3.0M, and could resist the sulfuric acid solution of 2.5M.

### Experiment 3

### Example 10

In example 10, an electrochemical capacitor was fabricated using the polymer matrix membrane obtained in Example 9. The polymer matrix membrane was immersed in a sulfuric acid solution of 2.5M for 24 hours to obtain a solid state electrolyte. Two electrodes (i.e., anode and cathode electrodes) made of ruthenium oxide (RuO₂) were prepared, each being surrounded by a polyimide (PI) frame. When forming the electrochemical capacitor, the solid state electrolyte was screen-printed on an area of one of the electrodes surrounded by the PI frame, and then the other one of the electrodes was disposed on the solid state electrolyte such that the PI frames of the two electrodes were registered with each other. Finally, the two electrodes were subjected to a heat pressing process at a temperature of 80° C. and a pressure of 35 bar such that the solid state electrolyte was sealed between the electrodes, thereby obtaining the electrochemical capacitor.

### Comparative Example 2 (CE 2)

A commercial electrochemical capacitor (UT4001, Ultra-cap Technology co., Taiwan) was used to serve as Comparative Example 2, in which a sulfuric acid solution was used as an electrolyte, and two electrodes of the electrochemical capacitor were made of ruthenium oxide (RuO₂).

Cyclic Voltammetry Test

The electrochemical capacitors of Example 10 and Comparative Example 2 were subjected to a cyclic voltammetry test using a potentiostat/galvanostat (PGSTAT 30, Autolab, Eco-Chemie, Netherland) at a scan rate of 100 mV/sec and a potential window ranging from −0.2V to 0.8V (vs. the standard hydrogen electrode (SHE)) at a temperature of 25° C. The cyclic voltammetry test was performed for testing the stability and reversibility of the electrochemical capacitors, and the results are shown in FIG. 7.

It can be seen from the cyclic voltammetry (CV) results of FIG. 7 that no apparent redox peak could be found in each cyclic voltammogram. This means that all of the electrochemical capacitors are rechargeable and are stable during their charge-discharge cycles. Besides, because each cyclic voltammogram is of a standard rectangular shape which is indicative of the properties of the ruthenium oxide electrodes, the electrochemical capacitors could be smoothly rechargeable.

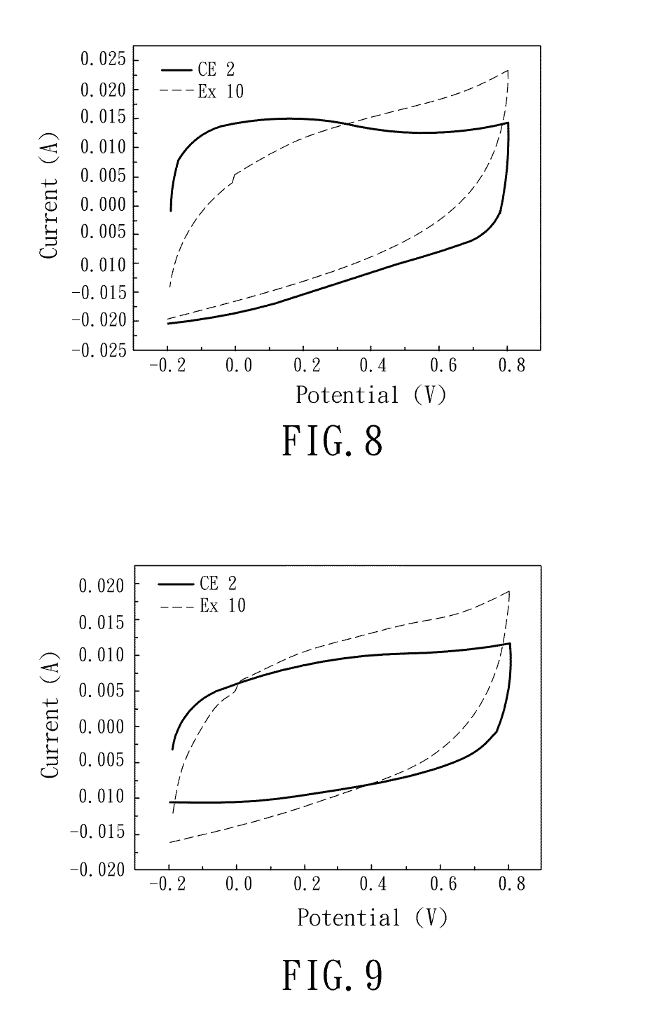

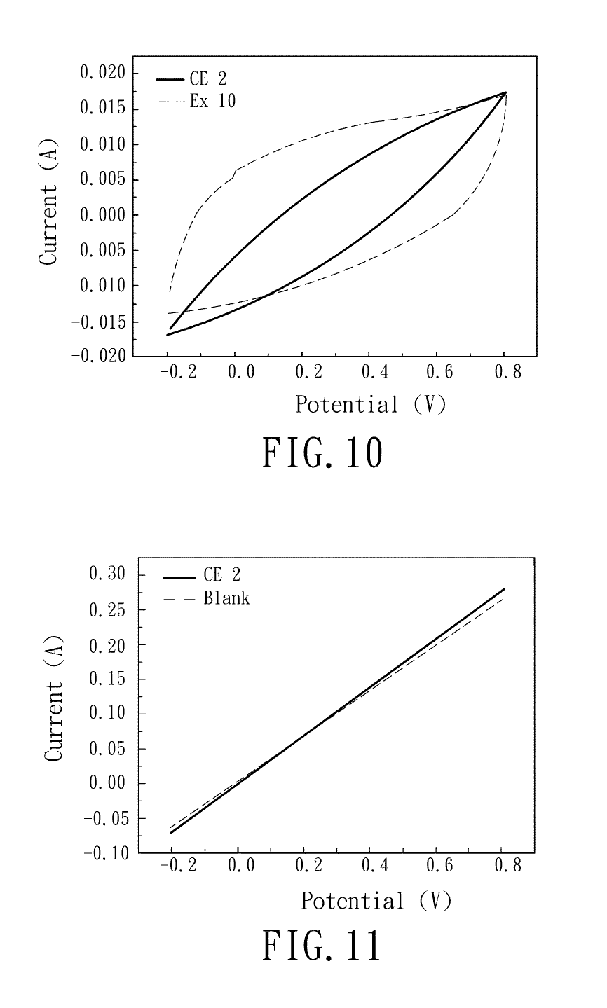

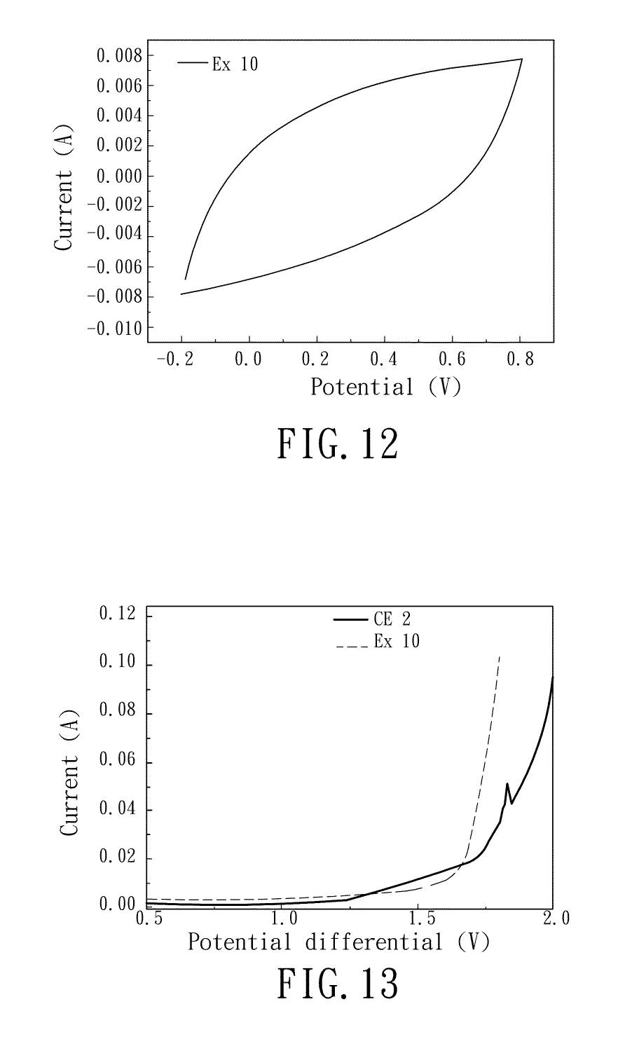

Each of the electrochemical capacitors of Example 10 and Comparative Example 2 was subjected to CV tests after being applied with a voltage of 1V at 85° C. for 24 hours, 36 hours, 48 hours, and 60 hours, respectively. FIGS. 8-10 are the CV results for the electrochemical capacitors after the electrochemical capacitors were each applied with a voltage of 1V at 85° C. for 24 hours, 36 hours and 48 hours, respectively. FIG. 11 shows the CV result for the electrochemical capacitor of Comparative Example 2 after the electrochemical capacitor was applied with a voltage of 1V at 85° C. for 60 hours, and the CV result for an electrochemical capacitor without an electrolyte (Blank). FIG. 12 shows the CV result for the electrochemical capacitor of Example 10 after the electrochemical capacitor was applied with a voltage of 1V at 85° C. for 60 hours. Each of the electrochemical capacitors of Example 10 and Comparative Example 2 was applied with a voltage of 1V at 85° C., and the impedance values and the charge quantities were measured at 24 hours, 36 hours, 48 hours, hours, 72 hours, 90 hours, and 102 hours. The impedance values for each of the electrochemical capacitors of Example 10 and Comparative Example 2 and their charge quantity ratio (R*) are shown in Table 3. Table 4 shows the capacitances for each electrochemical capacitor, which were calculated based on the charge quantity ratios (R*) listed in Table 3.

TABLE 3

| | | Time (hour) | | | | | | | |
|---|---|---|---|---|---|---|---|---|---|
| | | 0 | 24 | 36 | 48 | 60 | 72 | 90 | 102 |
| R* | | 0.98 | 0.92 | 1.14 | 1.15 | — | — | — | — |
| Imped- | CE 2 | 0.102 | 0.186 | 0.745 | 1.023 | X | X | X | X |
| ance | Ex 10 | 0.105 | 0.226 | 0.275 | 0.303 | 0.839 | 1.148 | 1.255 | X |
| (ohm) | | | | | | | | | |

R* is a value of the charge quantity of Example 10 divided by the charge quantity of Comparative Example 2, “X” means short circuit occured, and “—” means the value could not be obtained.

TABLE 4

| | Time (hours) | | | | |
|---|---|---|---|---|---|
| | 0 | 24 | 36 | 48 | 60 |
| Capacitance of | 418 | 163 | 112 | 100 | — |
| CE 2 (F/g) | | | | | |
| Capacitance of | 410 | 150 | 128 | 115 | 60 |
| Ex 10 (F/g) | | | | | |

From the results shown in Tables 3 and 4 and FIGS. 8-10, the impedance of the electrochemical capacitor of Comparative Example 2 was greatly increased after the electrochemical capacitor was applied with the voltage for 36 hours but could not be measured after 60 hours. It is noted from the result shown in FIG. 11 that after the electrochemical capacitor of Comparative Example 2 was applied with the voltage for 60 hours, the CV result therefor was substantially the same as that for the blank, which means that, at this stage, the electrochemical capacitor of Comparative Example 2 has lost its function. On the other hand, the electrochemical capacitor of Example 10 still functioned after being applied with the voltage for 60 hours at 85° C. (see the CV result shown in FIG. 12). Accordingly, the electrochemical capacitor of Example 9 made according to the process of this invention has a longer service life than that of the commercial electrochemical capacitor (Comparative Example 2).

Linear Sweep Voltammetry

The electrochemical capacitors of Example 10 and Comparative Example 2 were prepared for measuring decomposition potentials using a linear sweep voltammetry method. The decomposition potential is the minimum voltage required for continuous electrolysis of an electrolyte. In this test, a potential differential (vs. the standard hydrogen electrode (SHE)), which was applied between the two electrodes of each electrochemical capacitor, was scanned from 0.5V to 2V, and the current was recorded. FIG. 13 shows a graph plotting the current passing through each of the electrochemical capacitors versus the potential differential between the two electrodes, while the potential differential of the electrochemical capacitor was swept linearly in time.

It can be seen from the results shown in FIG. 13 that the decomposition potential of the commercial electrochemical capacitor (Comparative Example 2) is 1.25V, and the decomposition potential of the electrochemical capacitor according to the invention (Example 10) is 1.6V, which is higher than that of the Comparative Example 2. This means that under a potential differential of 1.25V, electrolysis reaction occurred in the commercial electrochemical capacitor, resulting in the generation of hydrogen and oxygen gases, and no electrolysis reaction occurred in the electrochemical capacitor of Example 10. It is speculated that because the polymer matrix membrane of the electrochemical capacitor of Example 10 has the partial intercalated structures, the sulfuric acid solution in the polymer matrix membrane can be retained. Therefore, the electrochemical capacitor of this invention is more stable than the commercial product of Comparative Example 2 when a relatively high voltage is applied thereto.

Impedance Measurement Test

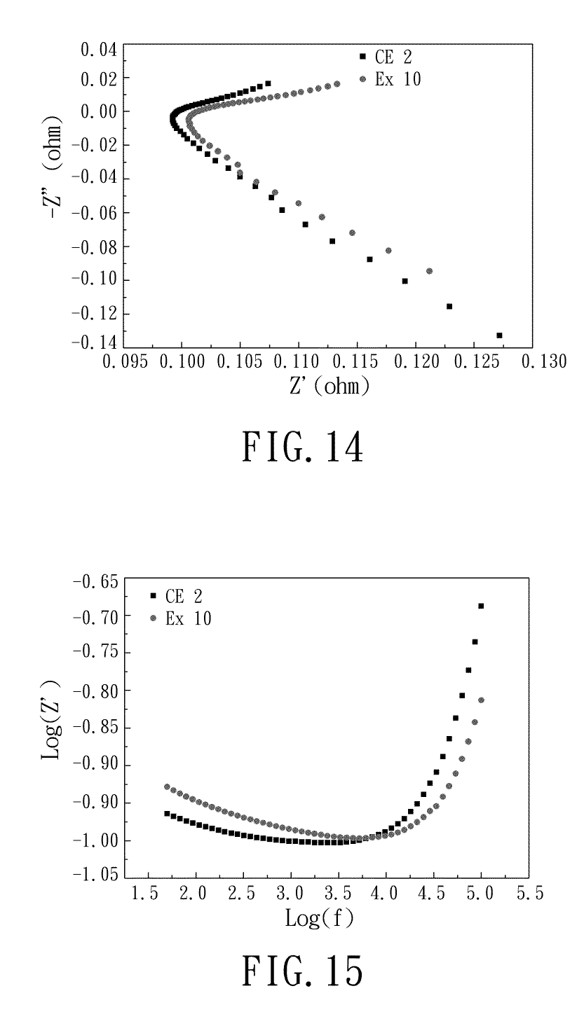

The electrochemical capacitors of Example 10 and Comparative Example 2 were prepared and subjected to an impedance measurement test which is substantially the same as that in Experiment 1, and the results are shown in FIGS. 14 and 15. FIG. 14 shows Nyquist plots for Example 10 and Comparative Example 2. FIG. 13 shows Bode plots for Example 10 and Comparative Example 2. Each Bode plot is constructed by plotting the logarithm of the magnitude of impedance (Z′) versus the logarithm of frequency (f).

It can be seen from the results shown in FIG. 14 that the impedance of Comparative Example 2 is 0.10 ohm, and the impedance of Example 19 is 0.11 ohm, which reaches the standard of commercial products.

It can be further seen from the results shown in FIG. 15 that the impedance (log(Z′)) of Comparative Example 2 increased at a frequency higher than 5623 Hz (e.g., log(f)>3.75). The impedance of Example 10 increased at a frequency higher than 10000 Hz (e.g., log(f)>4). This means that in comparison with the commercial electrochemical capacitor of Comparative Example 2, the electrochemical capacitor of Example 10 is more suitable to be applied to a high-frequency element.

With the solid state electrolyte prepared according to the process of this invention, the acid solution (especially the sulfuric acid solution) is less likely to leak out of the electrochemical capacitor. Compared with the commercial electrochemical capacitors, the electrochemical capacitor including the solid state electrolyte of this invention may be operated at a relatively high working voltage, a relatively high frequency and a relatively high temperature.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A process for preparing a solid state electrolyte used in an electrochemical capacitor having two electrodes, the process comprising:
(a) preparing a mixture of a water-retaining clay-based mineral component and a film-forming hydroxyl-containing polymer component;
(b) subjecting the mixture to a crosslinking reaction in a first aqueous solution to permit a crosslinking of the film-forming hydroxyl-containing polymer component so as to form a polymer matrix membrane with the water-retaining clay-based mineral component dispersed therein, the polymer matrix membrane including a polymer matrix and an ion-permeable film which encloses the polymer matrix and which has two major film surfaces for direct contact with the two electrodes, respectively; and
(c) treating the polymer matrix membrane with a second aqueous solution which includes an ionically conductive material that is dissociable into a plurality of positive and negative ions so as to permit the positive and negative ions to permeate the ion-permeable film to be retained in the polymer matrix, thereby forming the solid state electrolyte.

2. The process of claim 1, wherein the film-forming hydroxyl-containing polymer component includes polyvinyl alcohol.

3. The process of claim 2, wherein the water-retaining clay-based mineral component includes an inorganic clay which is modified by quaternary ammonium salt.

4. The process of claim 3, wherein the inorganic clay is in an amount ranging from 1 wt % to 12 wt % based on the total weight of the polymer matrix membrane.

5. The process of claim 3, wherein the inorganic clay is in an amount ranging from 3 wt % to 7 wt % based on the total weight of the polymer matrix membrane.

6. The process of claim 3, wherein the crosslinking reaction is implemented in presence of a crosslinking agent selected from the group consisting of glutaraldehyde, succindialdehyde, oxalaldehyde, and combinations thereof.

7. The process of claim 3, wherein the polyvinyl alcohol has a molecular weight ranging from 1800 to 4000000, and the polyvinyl alcohol in the polymer matrix membrane has a crosslinking degree ranging from 75% to 88%.

8. The process of claim 3, wherein the polymer matrix membrane is treated with the second aqueous solution for at least 20 hours.

9. The process of claim 8, the ionically conductive material is sulfuric acid, and has a concentration in the second aqueous solution ranging from 1.0M to 2.5M.
